(19) United States
(12) Patent Application Publication
(10) Pub. No.: US 2026/0197569 A1
(43) Pub. Date: Jul. 9, 2026

(54) SOUND CONTROL DEVICE AND METHOD FOR VEHICLE

(71) Applicants: Hyundai Motor Company, Seoul (KR); Kia Corporation, Seoul (KR)

(72) Inventor: Seokhoon Ryu, Hwaseong (KR)

(21) Appl. No.: 19/205,625

(22) Filed: May 12, 2025

(30) Foreign Application Priority Data
Nov. 5, 2024 (KR) 10-2024-0155123

(51) Int. Cl. H04R 1/02; G10L 21/02

(52) U.S. Cl. CPC H04R 1/025; G10L 21/02; H04R 2499/13

(57) ABSTRACT

A sound control device for a vehicle includes a plurality of speakers in which at least one of the speakers is configured to output a first voice signal, a microphone mounted inside the vehicle and configured to receive a second voice signal generated inside the vehicle, a first processing unit configured to adjust an intelligibility of the first voice signal to generate a third voice signal and adjust an intelligibility of the second voice signal to generate a fourth voice signal, and a second processing unit configured to control the first voice signal and the second voice signal to be output through a first speaker mounted on a first seat and the third voice signal and the fourth voice signal to be output through a second speaker mounted on a second seat.

### CROSS-REFERENCE TO RELATED APPLICATION

This application claims under 35 U.S.C. § 119(a) the benefit of Korean Patent Application No. 10-2024-0155123, filed on Nov. 5, 2024, the entire contents of which are incorporated herein by reference.

### BACKGROUND

### 1. Technical Field

The present disclosure relates to a sound control device and method for a vehicle, more particularly, to the sound control device and method configured to output sound via one or more speakers arranged in the vehicle.

### 2. Description of the Related Art

Hands-free calling using Bluetooth may satisfy the needs of vehicle occupants for making calls while a vehicle is traveling, and thus is important to promote safe driving of the vehicle.

By using a hands-free device, a vehicle occupant can make a call using a speaker arranged in the vehicle and a microphone that may be provided above a driver's seat, but there is a disadvantage in that a resonance phenomenon occurs and privacy is invaded by allowing other occupants to listen during the call.

For example, when a driver makes a phone call while driving, everyone in the vehicle may hear the phone call through the car speaker.

As a result, there is a problem in that an individual's privacy may be invaded, and in addition, in order to avoid the invasion of privacy, earphones and the like are used, but when the earphones are connected to the ears while driving, the earphones interfere with safe driving, and use of such devices may be illegal and/or inconvenient to the user.

### SUMMARY

The present disclosure is directed to providing a sound control device and method capable of ensuring security and privacy for the content of a hands-free call.

According to an aspect of the present disclosure, there is provided a sound control device for a vehicle including: a plurality of speakers mounted in the vehicle, at least one of the plurality of speakers being configured to output a first voice signal; a microphone mounted inside the vehicle and configured to receive a second voice signal generated inside the vehicle; a first processing unit configured to adjust an intelligibility of the first voice signal to generate a third voice signal and adjust an intelligibility of the second voice signal to generate a fourth voice signal; and a second processing unit configured to control the first voice signal and the second voice signal to be output through a first speaker of the plurality of speakers mounted on a first seat and the third voice signal and the fourth voice signal to be output through a second speaker of the plurality of speakers mounted on a second seat.

According to a further aspect, there is provided a sound control device including a speaker mounted on each seat headrest of a vehicle and configured to output a first voice signal of a call-connected terminal, a microphone mounted inside the vehicle and configured to receive a second voice signal generated inside the vehicle, a first processing unit configured to adjust an intelligibility of the first voice signal to generate a third voice signal and adjust an intelligibility of the second voice signal to generate a fourth voice signal, and a second processing unit configured to control the first voice signal and the second voice signal to be output through a first speaker mounted on a first seat and the third voice signal and the fourth voice signal to be output through a second speaker mounted on a second seat.

The third voice signal may have a lower intelligibility than the first voice signal, and the fourth voice signal may have a lower intelligibility than the second voice signal.

The first processing unit may adjust the intelligibility through at least one of pitch shifting, time stretching/compression, reverb, distortion, filtering, and phasing.

The first processing unit may adjust the intelligibility so that each of an articulation index (AI), a speech intelligibility index (SII), and a speech transmission index (STI) of each of the first voice signal and the second voice signal is a preset threshold value or lower.

The sound control device may further include an auxiliary microphone disposed in the second seat.

The first processing unit may calculate a transfer function between a voice signal transmitted from the microphone to the auxiliary microphone and a voice signal transmitted from the second speaker to the auxiliary microphone.

The first processing unit may reflect the transfer function and generate the fourth voice signal.

The second processing unit may adjust a time point at which the fourth voice signal is output based on a distance between the first seat and the second seat.

The first seat may be a seat of an utterer, and the second seat may be a seat other than the seat of the utterer.

The first seat may be one of rear row seats, and the second seat may be a driver's seat.

According to another aspect of the present disclosure, there is provided a method of controlling a sound, including receiving, by a communication device, a first voice signal of a call-connected terminal, adjusting, by a processor, an intelligibility of the first voice signal and generating a third voice signal, and performing, by the processor, control to output the first voice signal through a first speaker mounted on a first seat and output the third voice signal through a second speaker mounted on a second seat.

The third voice signal may have a lower intelligibility than the first voice signal.

The generating of the third voice signal may include adjusting the intelligibility through at least one of pitch shifting, time stretching/compression, reverb, distortion, filtering, and phasing.

The generating of the third voice signal may include adjusting the intelligibility so that each of an articulation index, a speech intelligibility index, and a speech transmission index of the first voice signal is a preset threshold value or lower and generating the third voice signal.

According to still another aspect of the present disclosure, there is provided a method of controlling a sound, including receiving a second voice signal generated inside a vehicle through a microphone mounted inside the vehicle, adjusting, by a processor, an intelligibility of the second voice signal and generating a fourth voice signal, and performing, by the processor, control to output the second voice signal through a first speaker mounted on a first seat and output the fourth voice signal through a second speaker mounted on a second seat.

The fourth voice signal may have a lower intelligibility than the second voice signal.

The generating of the fourth voice signal may include adjusting the intelligibility through at least one of pitch shifting, time stretching/compression, reverb, distortion, filtering, and phasing.

The generating of the fourth voice signal may include adjusting the intelligibility so that each of an articulation index, a speech intelligibility index, and a speech transmission index of the second voice signal is a preset threshold value or lower and generating the fourth voice signal.

The generating of the fourth voice signal may include calculating a transfer function between a voice signal transmitted from the microphone to an auxiliary microphone disposed in the second seat and a voice signal transmitted from the second speaker to the auxiliary microphone and reflecting the transfer function and generating the fourth voice signal.

The performing of the control to output the fourth voice signal may include adjusting a time point at which the fourth voice signal is output based on a distance between the first seat and the second seat.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIGS. 1 and 2 are views for describing a vehicle according to an embodiment;

FIG. 3 is a block diagram of a user terminal according to the embodiment;

FIG. 4 is a block diagram of a sound control device according to an embodiment;

FIGS. 5 and 6 are views for describing the operation of a processor according to the embodiment; and

FIGS. 7 to 10 are flowcharts of a method of controlling a vehicle according to an embodiment.

### DETAILED DESCRIPTION OF EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, preferred embodiments of the present disclosure will be described in detail with reference to the accompanying drawings.

However, the technical idea of the present disclosure is not limited to some embodiments to be described but may be implemented in various different forms, and within the scope of the technical idea of the present disclosure, one or more among components in the embodiments may be used by being selectively combined and substituted.

Further, unless specifically defined and described, terms used in the embodiments of the present disclosure (including technical and scientific terms) may be interpreted as meanings which are generally understood by those skilled in the art to which the present disclosure pertains, and commonly used terms such as terms defined in dictionaries may be interpreted in consideration of the contextual meaning of the related art.

The terms used in the embodiments of the present disclosure are for the purpose of describing the embodiments only and are not intended to limit the disclosure.

In the present specification, the singular forms may include the plural forms unless the context clearly dictates otherwise, and when described as “at least one (or one or more) among A, B, and (or) C,” it may include one or more of all possible combinations of A, B, and C.

In addition, when describing components of embodiments of the present disclosure, terms such as first, second, A, B, (a), (b), etc., may be used.

These terms are only for distinguishing the components from other components, and the essence, sequence, or order of the component is not limited by these terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” another component, the term “on (above) or under (below)” includes not only when two components are in direct contact with each other, but also when one or more other components are formed or disposed between the two components. Further, when a component is described as being “on (above) or below (under),” the description may include the meanings of an upward direction and a downward direction based on one component.

Hereinafter, embodiments will be described in detail with reference to the accompanying drawings, but the same or corresponding components are denoted by the same reference numerals regardless of the drawing numbers, and redundant descriptions thereof will be omitted.

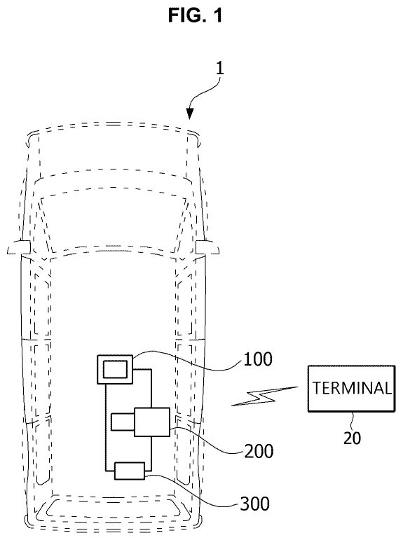

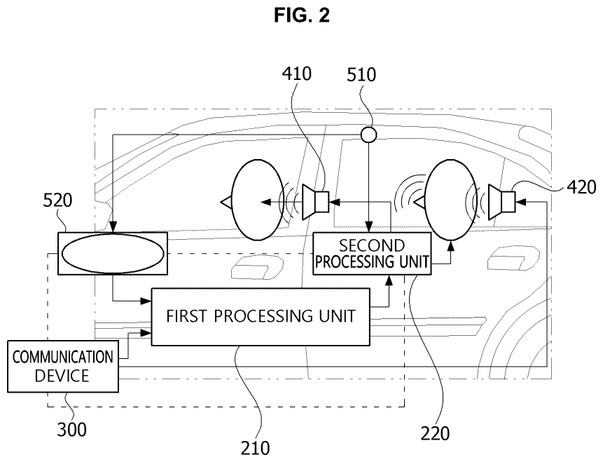

FIGS. 1 and 2 are views for describing a vehicle according to an embodiment. Referring to FIGS. 1 and 2, a vehicle 1 according to an embodiment may include audio video navigation and telematics (AVNT) 100 provided in a center fascia and used to control an audio device, an air conditioner, a Bluetooth device, and seat heating wires.

An input device for receiving user input may be disposed in the center fascia or AVNT 100, and in addition, a display device for displaying operation information for at least one of functions performed in the vehicle 1 may be disposed.

The input device may include hardware devices such as various buttons, switches, pedals, keyboards, mouses, trackballs, various levers, handles, sticks, or the like.

In addition, the input device may include a graphical user interface (GUI), such as a touch pad or the like, that is, a software device. The touchpad may be implemented as a touch screen panel (TSP) and form a mutual layer structure with a display panel of the display device.

The display device may function as a user interface. The display device may output and display an operating state, a control state, route/traffic information, remaining energy amount information, content requested by a driver, or the like, of the vehicle by the processor. In addition, the display device may be configured as a touch screen capable of detecting driver input to receive a request of the driver for instructing the processor.

The interior of a vehicle body may include a keyway into which a remote controller of a free-on-type (FOB) type or card type may be inserted. Here, the keyway may be provided on a dashboard or center fascia, and may be provided at a position adjacent to a driver's seat.

The vehicle 1 may transmit and receive information to and from a remote controller or terminal when the remote controller is inserted into the keyway or when authentication with the remote controller or terminal is completed through a wireless communication network.

The interior of the vehicle body may further include a start button for receiving an on/off command to start the vehicle. Accordingly, the vehicle starts when the start button is pressed by a user after authentication with the remote controller or terminal is completed.

The vehicle 1 may further include a communication device for transmitting and receiving information to and from at least one of an electronic device and a terminal 20 provided in the vehicle.

A communication device 300 may include one or more components that enable communication between components inside the vehicle, and may include, for example, at least one of a short-range communication module, a wired communication module, and a wireless communication module.

For example, the short-range communication module may include various short-range communication modules that transmit and receive signals using a wireless communication network in a short range, such as a Bluetooth module, an infrared communication module, a radio frequency identification (RF ID) communication module, a wireless local access network (WLAN) communication module, an NFC communication module, a Zigbee communication module, or the like.

For example, the wired communication module may include various wired communication modules such as a controller area network (CAN) communication module, a local area network (LAN) module, a wide area network (WAN) module, or a value added network (VAN) module, as well as various cable communication modules such as a universal serial bus (USB), a high definition multimedia interface (HDMI), a digital visual interface (DVI), recommended standard 232 (RS-232), power line communication, a plain old telephone service (POTS), or the like.

The wired communication module may further include a local interconnect network (LIN).

In addition, in addition to a WiFi module and a wireless broadband (WiBro) module, the wireless communication module may include a wireless communication module that supports various wireless communication methods such as global system for mobile communication (GSM), code division multiple access (CDMA), wideband code division multiple access (WCDMA), universal mobile telecommunications system (UMTS), time division multiple access (TDMA), long term evolution (LTE), and the like.

The user terminal 20 communicates with the vehicle 1, receives at least one of a vehicle door lock and unlock command, a tailgate lock and unlock command, a start command, and a lamp lighting command as a user input, and transmits information corresponding to the received command to the vehicle. The user terminal 20 may transmit the information corresponding to the received command to the vehicle as a communication signal.

The user terminal 20 may be implemented as a computer or portable terminal that may communicatively access the vehicle through a network.

Here, the computer may include, for example, a notebook computer, a desktop computer, a laptop computer, a tablet PC, a slate PC, and the like, equipped with a web browser, and the portable terminal may be, for example, a wireless communication device that guarantees portability and mobility, including all types of handheld-based wireless communication devices, such as a personal communication system (PCS), a global system for mobile communications (GSM), a personal digital cellular (PDC), a personal handyphone system (PHS), a personal digital assistant (PDA), an international mobile telecommunication (IMT)-2000 terminal, a code division multiple access (CDMA)-2000 terminal, a W-code division multiple access (W-CDMA) terminal, a wireless broadband Internet (WiBro) terminal, a smartphone, or the like, and a wearable device, such as a watch, a ring, a bracelet, an anklet, a necklace, glasses, contact lenses, or a head-mounted-device (HMD), or the like.

In the embodiment, the user terminal 20 may communicate with the vehicle through Bluetooth (Bluetooth Low Energy: BLE) communication. The user terminal 20 may communicate by the Bluetooth beacon standard (iBeacon).

The AVNT 100 is a term referring to an information and entertainment system in the vehicle, and may refer to a system that integrates navigation, audio, video, and communication functions. The AVNT 100 may output a message generated by a processor 200 in at least one of a visual manner, an audible manner, or a combination thereof.

The AVNT 100, the processor 200 and the communication device 300 may be implemented as one module, but in the embodiment, will be separately described for convenience of description.

The AVNT 100 may refer to a component that provides a hardware interface integrated into the system in the vehicle. The AVNT 100 may perform system control targeting screens, buttons and various integrated information and entertainment functions.

The AVNT 100 is installed in a center or console of the vehicle dashboard and may provide vehicle information and an entertainment interface. The information and entertainment system may include AM/FM radio, satellite radio, DVDs/CDs, cassette tapes, USB MP3, dashcams, GPS navigation, Bluetooth, Wi-Fi, and the like, and may also provide state information on the vehicle system. In addition, the AVNT 100 may perform functions such as voice control, motion recognition, and the like.

The processor 200 may control the vehicle body, including the vehicle, doors, windows, keys (digital keys, smartphone keys, FOB), and the like. The processor 200 may perform a body control function (BCM), a smart key entry/start function (SMK), a tire pressure monitoring function (TPMS), an immobilizer function (IMMO), digital key authentication (IAU), an autonomous parking related control function (PDW), and the like. For example, the processor 200 may be a body domain controller (BDC), but is not limited thereto and may be used as a meaning that encompasses a platform controller that provides electronic convenience functions to a body domain area.

A speaker 400 may be mounted on each vehicle seat headrest and may output a first voice signal of a call-connected terminal.

In the embodiment, the speaker 400 may be mounted on the vehicle seat headrest to provide a personalized audio experience inside the vehicle. The speaker 400 may be disposed in each seat, and two speakers may be disposed on each of the left and right sides of the vehicle headrest.

The speaker 400 may be embedded inside the headrest and may transmit direct sound at a position close to occupant's ears. The speaker 400 may be used for purposes such as Bluetooth calls, navigation guidance voice, and the entertainment system inside the vehicle.

The speaker 400 may be integrated into the headrest of the vehicle 1 and may be configured as a small-sized full-range speaker. In this way, sound may be directly transmitted from the position close to the occupant's ears, so that clear sound may be provided without being disturbed by surrounding noise.

In addition, since sound is transmitted through a short path near an occupant's head, the sound is less affected by surrounding noise, and in this way, voice may be clearly transmitted even in environments with noise inside the vehicle (engine noise, wind noise, or the like).

In addition, the speaker 400 may reduce noise generated outside the vehicle (road noise, engine noise, or the like) by applying active noise cancellation (ANC) technology. The system may operate in a manner of canceling out external noise through frequency band analysis to allow the occupant to receive sound in a quieter environment.

A microphone 510 may be mounted inside the vehicle and may receive a second voice signal generated inside the vehicle. The microphone 510 may be installed in various positions inside the vehicle to receive the voice of the occupant in the vehicle as clearly as possible.

For example, the microphone 510 may be mounted in a headliner portion of the vehicle. The position is close to the mouth of the occupant to receive voice efficiently and receive relatively less ambient noise (e.g., wind noise coming in through the window).

For example, the microphone 510 may be mounted on or near a rearview mirror to collect the voice of the occupant.

For example, the microphone 510 may be disposed in a manner of being integrated into the AVNT 100 of the dashboard.

For the microphone 510, a single microphone, dual microphones, or multiple microphones may be applied.

The single microphone may receive the voice of the driver using only one microphone in the vehicle.

The dual microphones may provide better noise suppression and echo cancellation performance by using two microphones. The dual microphones may be used so that one microphone may collect voice of the occupant and the other may collect ambient noise, and then the voice and the noise are compared to remove the noise and extract the voice.

The multiple microphones may use a multiple microphone array to enhance the directionality of the sound and selectively receive only the voice coming from a specific direction through beamforming technology.

In the following embodiment, an example in which the single microphone is mounted on the headliner of the vehicle will be described.

Auxiliary microphones 520 may be disposed on both sides of a second seat.

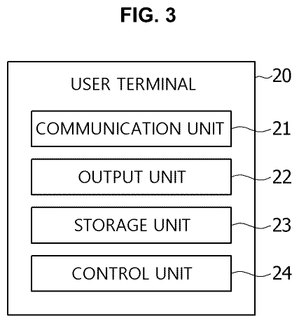

FIG. 3 is a block diagram of the user terminal according to the embodiment. Referring to FIG. 3, the user terminal 20 may include a communication unit 21, an output unit 22, a storage unit 23, and a control unit 24.

The user terminal 20 may include a smartphone, a smart pad, a laptop, or the like, that the user may carry. The user terminal 20 may store a digital key that generates authentication information for controlling functions such as locking and unlocking of vehicle doors, remote starting, emergency alarm, trunk opening, and the like.

The communication unit 21 may include a transceiver that transmits and receives information using an antenna, a communication circuit, a communication processor, and the like, and may perform short-range communication with the vehicle. According to the embodiment, the communication unit 21 may perform near field communication (NFC) communication or ultra-wideband (UWB) communication.

The output unit 22 may output information stored in the user terminal 20 in at least one of a visual manner, an audible manner, or a combination thereof. According to the embodiment, the output unit 22 may be implemented as a display device employing a liquid crystal display (LCD) panel, a light emitting diode (LED) panel, an organic light emitting diode (OLED) panel, a plasma display panel (PDP), or the like. The liquid crystal display may include a thin film transistor liquid crystal display (TFT-LCD). The output unit 22 may be implemented integrally with an input unit (not shown) by a touch screen panel (TSP).

The storage unit 23 may store at least one algorithm that performs calculation or execution of various commands for the operation of the user terminal 20 according to one embodiment of the present disclosure. The storage unit 23 may include at least one storage medium of a flash memory, a hard disk, a memory card, a read-only memory (ROM), a random-access memory (RAM), an electrically erasable programmable read-only memory (EEPROM), a programmable read-only memory (PROM), a magnetic memory, a magnetic disk, and an optical disc. The storage unit 23 may store driver information for a plurality of vehicles.

The control unit 24 may be implemented by various processing devices such as a microprocessor having a built-in semiconductor chip capable of performing calculation or execution of various commands, and may control the operation of the user terminal 20 according to one embodiment of the present disclosure. The control unit 24 may be electrically connected to the communication unit 21, the output unit 22, and the storage unit 23 through a wired cable or various circuits to transmit electrical signals including control commands and the like, and may transmit and receive electrical signals including control commands and the like through various wireless communication networks such as a controller area network (CAN).

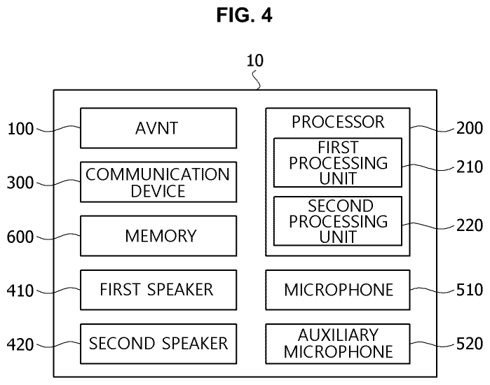

FIG. 4 is a block diagram of a sound control device according to an embodiment.

Referring to FIG. 4, a sound control device 10 is configured to include an AVNT 100, a processor 200, a communication device 300, and a memory 600, and may perform short-range communication with the user terminal 20.

In the embodiment, the user terminal 20 may perform hands-free call mode and phone call mode functions. For the hands-free call mode, the user terminal 20 may be equipped with a short-range communication module for short-range communication with the vehicle 1. The short-range communication module may be a Bluetooth module. In the embodiment, the user terminal 20 may activate the hands-free call mode or the phone call mode according to a call mode command message transmitted through short-range communication from the communication device of the vehicle 1.

In the embodiment, the hands-free call mode may be a mode in which a call channel of the user terminal 20 is set using the AVNT 100 of the vehicle 1, and may refer to a mode in which at least one of a video signal and a voice signal for a call or digital content playback is input/output through the AVNT 100 of the vehicle.

In the embodiment, the phone call mode may be a mode in which a call channel is set using the user terminal 20, and may refer to a mode in which at least one of a video signal and a voice signal for a call or digital content playback is input/output through the user terminal 20.

The communication device 300 may perform pairing between the user terminal 20 and the vehicle 1 using a Bluetooth signal to transmit and receive a voice signal.

The communication device 300 may include a transceiver that transmits and receives information using an antenna, a communication circuit, a communication processor, and the like, and may perform short-range communication with the user terminal 20. According to the embodiment, the communication device 300 may perform Bluetooth communication, NFC communication, or UWB communication. The communication device 300 may be installed near a door handle of the vehicle 1, and may request authentication information when it is determined that the user terminal is approaching within a predetermined distance.

When the vehicle 1 is started, the hands-free device using the Bluetooth module turns on the Bluetooth function and enters a connection standby state, and the driver works to connect the vehicle and the mobile phone. Once the connection is complete, the driver may make a phone call through Bluetooth hands-free.

In the Bluetooth standard, since Bluetooth 1.0 specifies a data transmission speed of 1 Mbps and a transmission distance of 10 to 100 m, and uses a high radio frequency of 2.4 GHz, communication is possible even when there are obstacles.

The communication device 300 according to the embodiment operates so that when the driver carrying the mobile phone outside the vehicle 1 operates a digital key to remotely start the vehicle 1 under the control of the processor 200, the communication device 300 automatically connects the vehicle 1 and the user terminal 20, thereby allowing the driver to get into the vehicle 1 and use the hands-free function right away.

The processor 200 may perform overall control of the vehicle 1. The processor 200 may be configured to execute applications and instructions stored in the memory. The processor 200 may include a first processing unit 210 and a second processing unit 220.

The processor 200 may be a main CPU for overall control of the sound control device 10. In the embodiment, the processor 200 executes a Bluetooth application (BT application) to support the hands-free call mode through Bluetooth communication with the user terminal through communication between the Bluetooth application and the communication device.

The processor 200 may process the sound signal in real time through a digital signal processor (DSP). The DSP may analyze the input sound signal and perform functions such as speech intelligibility, distortion removal, noise reduction, and the like, to provide optimal sound quality. For example, the DSP may perform processing during the Bluetooth call to improve the intelligibility of the call voice and distinguish the navigation voice guidance from other sounds.

In addition, the processor 200 may compensate for reflection, absorption, and distortion of sound due to a complex acoustic path inside the vehicle. The processor 200 may minimize the problems occurring in the acoustic path using phase control technology and an acoustic path compensator, and ensure that the sound output from the speaker is accurately transmitted to the occupant's ears.

In addition, the processor 200 may apply a distortion filter and a sound correction algorithm to prevent the sound provided from the speaker from being distorted by distortion or reverberation occurring inside the vehicle. Thereby, the occupant may receive clear voice, and the performance may be especially exhibited during high-speed driving or in noisy environments.

The processor 200 may clearly extract only an occupant's voice through an algorithm that distinguishes between environmental noise and voice signals collected from the microphone and removes background noise. The processor 200 may remove background noise by analyzing the voice received from the microphone and filtering out a frequency band with a lot of noise.

In addition, the processor 200 may detect a noise pattern received through two or more microphones and generate an opposite signal to cancel out the noise.

In addition, the processor 200 may remove echo generated in a process in which the occupant's voice is played from the speaker and then input into the microphone again when the microphone and speaker simultaneously operate. The processor 200 may detect a signal coming from the speaker in real time and suppress echo by removing the signal from the input signal of the microphone.

In addition, the processor 200 may help to clearly collect the occupant's voice even in a noisy environment by concentrating a reception direction of the microphone toward the occupant's voice. The processor 200 may emphasize a voice signal (occupant's voice) coming from a specific direction through a plurality of microphones and suppress a signal (ambient noise) coming from another direction, thereby excluding other noises inside the vehicle and clearly collecting only the driver's voice.

In addition, the processor 200 may detect a moment when the occupant is actually speaking and control the operation of the microphone to receive only the voice signal. In this way, it is possible to prevent unnecessary background noise from being transmitted to the other party and improve call quality.

In the embodiment, the first seat and the second seat may refer to fixed seats. For example, the first seat may be one of rear row seats, and the second seat may be the driver's seat.

Alternatively, in the embodiment, the first seat may be a seat of an utterer, and the second seat may be a seat other than the seat of the utterer. The processor 200 may detect a direction in which the voice signal is collected to determine the seat of the utterer. Accordingly, the processor 200 may perform control so that the first voice signal and the second voice signal are output to the seat of the utterer positioned in the direction in which the voice signal is collected. The processor 200 may perform control so that a third voice signal and a fourth voice signal are output to seats other than the seat of the utterer.

In this case, when the utterer is changed and the position of the first seat is changed, the processor 200 may perform control so that the first voice signal and the second voice signal are output to the changed first seat in real time and perform control so that the third voice signal and the fourth voice signal are output to the remaining second seat.

In the following embodiments, an example in which the first seat is one of the rear row seats and the second seat is the driver's seat will be given.

The first processing unit 210 may generate the third voice signal by adjusting the intelligibility of the first voice signal and may generate the fourth voice signal by adjusting the intelligibility of the second voice signal.

The third voice signal may have a lower intelligibility than the first voice signal, and the fourth voice signal may have a lower intelligibility than the second voice signal. In addition, the third and fourth voice signals may have different intelligibilities. For example, the fourth voice signal may have a lower intelligibility than the third voice signal.

The first processing unit 210 may reduce the intelligibility of the first voice signal input through the other party's terminal during the hands-free call to generate the third voice signal.

In addition, the first processing unit 210 may reduce the intelligibility of the third voice signal of the utterer input through the microphone to generate the fourth voice signal.

The first processing unit 210 may adjust the intelligibility through at least one of pitch shifting, time stretching/compression, reverb, distortion, filtering, and phasing.

The pitch shifting may refer to a technique that controls a pitch of a voice by changing the frequency of the voice signal. The first processing unit 210 may increase or decrease the frequency of an original voice through the pitch shifting, thereby making it difficult to recognize the voice.

The pitch shifting changes frequency components of a voice signal and changes only a frequency of the voice while maintaining an original time axis. For example, when the pitch is raised, the voice sound becomes shriller, while when the pitch is lowered, the voice sound becomes deeper and duller.

When an original frequency pattern of the voice is distorted, it becomes difficult for a listener to naturally recognize the voice. When the pitch of the voice changes, the intelligibility of pronunciation decreases, and in particular, the phonemes of the language become more difficult to distinguish.

For example, when an occupant in the second seat lowers the pitch of his/her uttered voice by the pitch shifting, his/her voices sound deep and dull, making it difficult for the driver to understand the utterance.

The time stretching/compression is a technique of adjusting a playback speed of a voice signal. The first processing unit 210 may cause the voice to be slower or faster played by increasing or decreasing the time axis of the voice signal.

The time stretching is a process of slowing down the voice to increase a playback time, while time compression is a process of speeding up the voice to decrease the playback time. In the processes, the pitch of the voice does not change, and only the time axis is distorted as the signal is stretched or compressed.

When the playback speed becomes abnormally slow or fast, it becomes difficult to naturally recognize the voice. In particular, when the voice is compressed too quickly, the pronunciation becomes muffled and difficult to understand, and when the voice is compressed too slowly, the voice becomes distorted and intelligibility decreases.

For example, when the voice uttered by the occupant in the second seat is slowly played back through the time stretching, the driver may feel that the voice is abnormal and have difficulty understanding the voice.

The reverb is an effect in which the sound is reflected and a reverberation is naturally added. The first processing unit 210 may implement the corresponding effect by allowing the original voice to be reflected so that the original voice is heard as a multiple-overlapped sound.

A simulation is performed on natural reverberation of the voice that bounces off walls, ceilings, and the like, and reaches the ears through several paths after being output. The stronger the reverb, the more the voice signal overlaps, and a boundary of sounds becomes blurred, thereby making it difficult to hear accurate pronunciation.

As reverberation is added, the voice drags on longer and the clarity decreases, making it difficult for a listener to understand the voice, especially when high-speed voice or complex pronunciations are overlapped.

For example, when the reverb is added to the utterance of the occupant in the second seat, the intelligibility is reduced while the voice is echoing, and the driver has difficulty in distinguishing the pronunciation due to the reverberation.

The first processing unit 210 may add noise to the signal or damage the voice signal itself by excessively amplifying or clipping the voice signal through distortion.

The distortion amplifies the voice signal to a certain limit or beyond, causing the signal to become abnormally strong, or the signal to be intentionally cut off or distorted. In this way, the voice becomes distorted due to excessive noise and pronunciation becomes unclear.

When the voice is excessively amplified, causing a cracking sound or too much noise, pronunciation becomes muffled and it becomes difficult to convey clear linguistic information.

For example, when distortion is applied to the voice of the occupant in the second seat, the voice becomes harsh and distorted, making it impossible for the driver to understand the utterance.

The first processing unit 210 may emphasize or remove a specific frequency band from the voice signal through filtering. The first processing unit 210 may distort a specific portion of the voice using low-pass, high-pass, band-pass filters or the like.

The low-pass filter removes high-frequency components and passes only low-frequency components, while the high-pass filter removes low-frequency components and passes only high-frequency components. The band-pass filter passes only mid-range frequencies and removes low and high frequencies.

When certain frequencies are removed from the voice signal through filtering, important portions of pronunciation are lost, thereby reducing intelligibility. For example, when consonants are muffled through high-pass filtering, it becomes difficult for the listener to distinguish pronunciation.

For example, when a high-pass filter is applied to the utterance of the occupant in the second seat to remove low-frequency components, the voice sounds shrill and unnatural, making it difficult for the driver to properly understand the voice.

The phasing refers to a technique that creates a unique swirling effect by subtly shifting the phase of the voice signal. The first processing unit 210 may create a time difference in the voice signal by adding a phase shift and may modify the voice in a way that the signal overlaps or waveforms collide.

The phasing splits the voice signal into two, delays one of the split signals by a small amount of time, and then puts the split signals back together. Thereby, an interference effect occurs, causing a change in sound in a certain frequency band, such as attenuation or amplification.

When the phase shifting is severe, pronunciation becomes distorted and difficult to recognize as the voice echoes and an abnormal swirling sound is added. This may have an effect of lowering speech intelligibility.

For example, when a phasing effect is added to the utterance of the occupant in the second seat, the voice echoes and is distorted, making it difficult for the driver to understand the original utterance.

The first processing unit 210 may apply the aforementioned voice signal processing techniques to modify specific characteristics (frequency, time, phase, or the like) of the first voice signal and the second voice signal, thereby lowering the intelligibility of the original voice. Thereby, it may become difficult for the driver to clearly recognize the voice, and in particular, by distorting the voice in the call or speech transmission, effects, such as privacy protection, call content blocking, and the like, may be obtained.

The first processing unit 210 may apply different voice signal processing techniques to the first voice signal and the second voice signal to lower the intelligibility of each voice signal.

The first processing unit 210 may calculate a transfer function between a voice signal transmitted from the microphone to an auxiliary microphone and a voice signal transmitted from a second speaker 420 to the auxiliary microphone.

The first processing unit 210 may generate the fourth voice signal by reflecting the transfer function.

The first processing unit 210 may play a role of correcting changes that occur in an actual acoustic environment when the voice uttered within the vehicle is transmitted to the driver. In this way, issues that may occur when the voice signal is distorted on the complex acoustic path inside the vehicle may be settled.

To this end, the first processing unit 210 may mathematically model the acoustic path characteristics between the speaker and the driver and correct the voice signal accordingly.

A transfer function S may be expressed by the following Equation 1.

S=P(z)/S(z) [Equation 1]

In Equation 1, P(z) is a voice signal value in which acoustic environment characteristics for a first path through which a voice is transmitted between the microphone and the auxiliary microphone are reflected, and S(z) is a voice signal value in which acoustic environment characteristics for a second path through which a voice is transmitted between the second speaker 420 and the microphone are reflected.

The first path is a sound transmission path through which the spoken voice of the occupant in the first seat passes when the spoken voice reaches the driver's ears inside the vehicle from the mouth of the occupant. In the sound transmission path, the voice signal is distorted by various factors (reflection, absorption, refraction, or the like) inside the vehicle. Specifically, the voice may be reflected and absorbed by structures (the glass, dashboard, seats, and the like) inside the vehicle, causing a frequency response to unevenly vary.

Therefore, the spoken voice of the occupant in the first seat is transmitted to the driver through the complex acoustic environment inside the vehicle, and some frequency bands may be excessively emphasized or attenuated.

The second path is an acoustic path through which the voice reproduced from the speaker is transmitted to the auxiliary microphone. Since the sound signal generated from the speaker is transmitted again through the acoustic environment inside the vehicle, frequency characteristics and sound distortion are also experienced on the path.

Inside the vehicle, the voice is not simply transmitted as the voice is uttered, but is distorted in various ways depending on the acoustic environment characteristics inside the vehicle. In particular, the following problems may occur when the voice output from the speaker is transmitted to the driver:

For example, the acoustic path may become complex as a certain frequency band is emphasized or attenuated by an internal structure of the vehicle and the voice is reflected inside the vehicle so that the voice signal overlaps.

In addition, when the same voice reaches the driver through multiple paths, a problem where the voice is heard as two distinct voices rather than one voice may occur.

The first processing unit 210 measures the acoustic environment characteristics of the first and second paths. In order to measure the acoustic environment characteristics, the microphone inside the vehicle is used to analyze a frequency response, reflection, distortion, and the like, between the paths.

The first processing unit 210 adjusts the signal output from the speaker by applying a correction value for each frequency based on the measured path characteristics. That is, a relationship between the acoustic environment characteristics reflected when the actual spoken voice is transmitted to the driver and the acoustic environment characteristics reflected in the voice signal transmitted from the speaker to the driver may be calculated as a transfer function, and the fourth voice signal may be generated by reflecting the calculated transfer function.

The first processing unit 210 may adjust the intelligibility so that each of an articulation index, a speech intelligibility index, and a speech transmission index of each of the first voice signal and the second voice signal is a preset threshold value or lower.

The articulation index is an indicator that evaluates how well a voice signal is transmitted in a specific environment, in particular, how well individual phonemes of a speech are understandable to the listener. The first processing unit 210 may evaluate the intelligibility of each frequency band and quantify how well the voice signal is heard in each band.

The first processing unit 210 may calculate the articulation index by measuring a signal-to-noise ratio (SNR) for each frequency band through which the voice signal passes. The first processing unit 210 may derive a score by analyzing how well the voice is heard in each frequency band due to an audible range and noise.

The first processing unit 210 may calculate the articulation index as a value between 0 and 1. An articulation index of 0 may mean that the voice signal is not heard at all, while an articulation index of 1 may mean that the voice signal is heard very clearly.

The speech intelligibility index is an indicator that evaluates the overall understandability of the speech sounds based on the intelligibility for each frequency band of the voice signal.

The first processing unit 210 may divide the frequency band into several bands and evaluate how well the voice signal is heard in each band. The first processing unit 210 more accurately reflects the effect of a specific frequency band on the speech intelligibility by applying a SNR value and a weight. The first processing unit 210 may calculate the speech intelligibility index by giving a greater weight to the intelligibility of an important frequency band (a consonant and the like).

The first processing unit 210 may calculate the speech intelligibility index as a value between 0 and 1. A speech intelligibility index of 0 may mean that the voice signal is not heard at all, while a speech intelligibility index of 1 may mean that the voice signal is heard very clearly.

The speech transmission index is an indicator that evaluates how clearly a voice signal is transmitted in an acoustic environment or communication system, and the first processing unit 210 may evaluate the understandability of the voice by considering both temporal and frequency distortions.

The first processing unit 210 may evaluate the intelligibility by analyzing whether the voice signal is distorted in frequency and time domains and how the signal-to-noise ratio has changed.

The first processing unit 210 may evaluate how much the voice is distorted by measuring a modulation transfer function (MTF) that occurs in a process of transmitting the voice signal. The first processing unit 210 may analyze a temporal variation of the voice signal and evaluate the way in which the voice is transmitted, including the effects of reverberation, echo, distortion, noise, and the like, using the modulation transfer function. Since the modulation transfer function is calculated by reflecting both the frequency band and temporal distortion, the speech intelligibility in the actual acoustic environment may be more accurately evaluated.

The first processing unit 210 may calculate the speech transmission index as a value between 0 and 1. A speech transmission index of 0 may mean that the voice signal is not heard at all, while a speech transmission index of 1 may mean that the voice signal is heard very clearly.

The first processing unit 210 may generate the third voice signal by applying the aforementioned voice signal processing method to adjust the intelligibility so that each of the articulation index, the speech intelligibility index, and the speech transmission index of the first voice signal is a preset threshold value or lower.

In addition, the first processing unit 210 may generate the fourth voice signal by applying the aforementioned voice signal processing method to adjust the intelligibility so that each of the articulation index, the speech intelligibility index, and the speech transmission index of the second voice signal is a preset threshold value or lower.

The second processing unit 220 may perform control to output the first voice signal and the second voice signal through a first speaker 410 mounted on the first seat, and output the third voice signal and the fourth voice signal through the second speaker 420 mounted on the second seat.

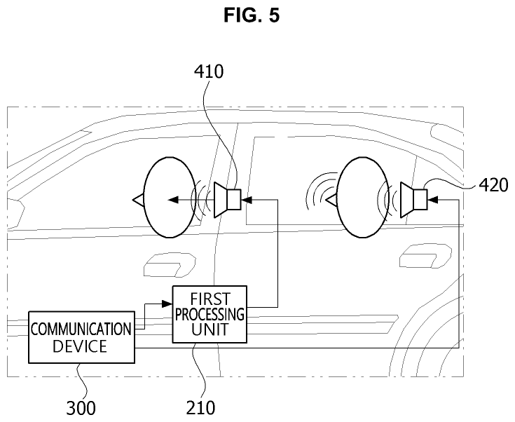

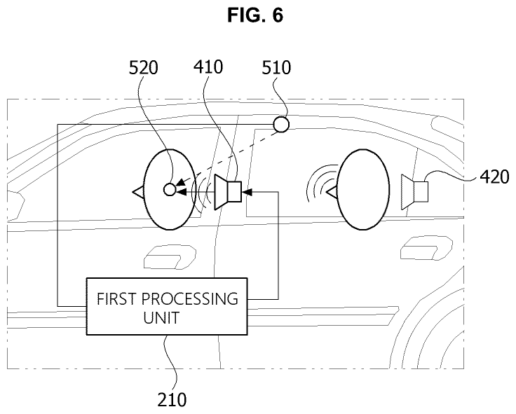

FIGS. 5 and 6 are views for describing the operation of the processor according to the embodiment.

Referring to FIG. 5 together, a first voice signal received through the other party's terminal is converted into a third voice signal having a low intelligibility through the first processing unit. The second processing unit 220 outputs the first voice signal that has not been converted to the speaker of the first seat and outputs the third voice signal to the speaker of the second seat, thereby preventing the driver from accurately recognizing the utterance content of the other party.

Referring to FIG. 6 together, the second voice signal uttered inside the vehicle is converted into a fourth voice signal having a low intelligibility through the first processing unit. The second processing unit 220 lowers the intelligibility of the voice signal uttered by the occupant in the first seat and outputs the lowered signal to the headrest speaker of the driver, thereby preventing the driver from accurately recognizing the utterance content of the occupant in the first seat. In this case, it becomes more difficult for the driver to recognize the call content as he or she hears the utterance contents of the occupant in the first seat and the fourth voice signal together.

In this case, the second processing unit 220 may adjust a time point at which the fourth voice signal is output based on a distance between the first seat and the second seat. The second processing unit 220 may calculate a transmission time at which the utterance content of the utterer in the first seat is directly transmitted to the driver according to the distance between the first seat and the second seat. The second processing unit 220 adjusts an output time point of the fourth voice signal by considering the transmission time so that the directly transmitted voice signal and the output time point of the fourth voice signal may be synchronized and transmitted to the driver. When the synchronization process is not performed, the driver repeatedly hears the voice signal containing the same content, which may cause the driver to feel dizzy or nauseous and affect safe driving.

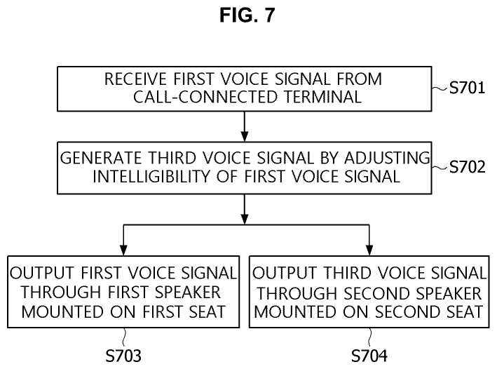

FIG. 7 is a flowchart of a method of controlling a vehicle according to an embodiment. Referring to FIG. 7, first, the communication device receives a first voice signal of a call-connected terminal (S701).

Next, the processor adjusts the intelligibility of the first voice signal to generate a third voice signal. The third voice signal has a lower intelligibility than the first voice signal (S702).

Next, the processor outputs the first voice signal through the first speaker mounted on the first seat (S703).

At the same time, the processor outputs the third voice signal through the second speaker mounted on the second seat (S704).

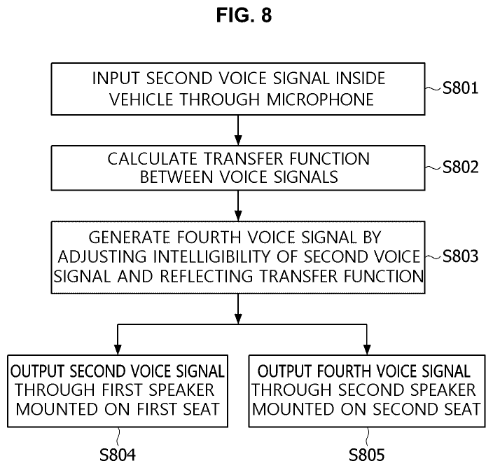

FIG. 8 is a flowchart of a method of controlling a vehicle according to another embodiment. Referring to FIG. 8, a second voice signal generated inside the vehicle is input through the microphone mounted inside the vehicle (S801).

Next, the processor calculates a transfer function between a voice signal transmitted from the microphone to the auxiliary microphone disposed in the second seat and a voice signal transmitted from the second speaker to the auxiliary microphone (S802).

Next, the processor adjusts the intelligibility of the second voice signal and generates a fourth voice signal by reflecting the calculated transfer function together. The fourth voice signal has a lower intelligibility than the second voice signal (S803).

Next, the processor outputs the second voice signal through the first speaker mounted on the first seat (S804).

At the same time, the processor outputs the fourth voice signal through the second speaker mounted on the second seat. In this case, the processor adjusts a time point at which the fourth voice signal is output based on the distance between the first seat and the second seat (S805).

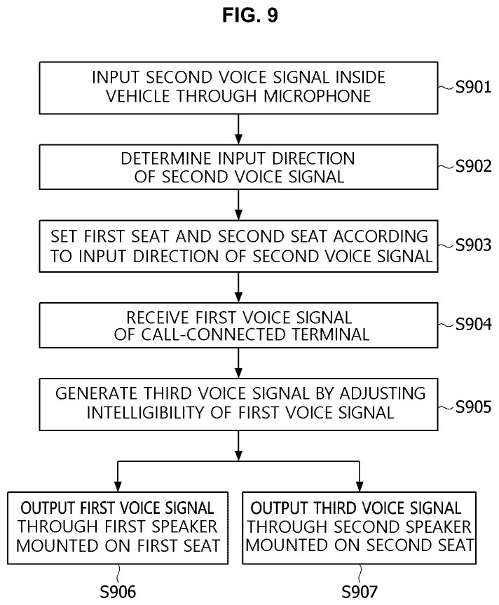

FIG. 9 is a flowchart of a method of controlling a vehicle according to still another embodiment. Referring to FIG. 9, a second voice signal generated inside the vehicle is input through the microphone mounted inside the vehicle (S901).

Next, the processor determines an input direction of the second voice signal (S902).

Next, the processor sets a seat positioned in the input direction of the second voice signal as the first seat, and sets other seats except the first seat as the second seat (S903).

Next, the communication device receives a first voice signal of the call-connected terminal (S904).

Next, the processor adjusts the intelligibility of the first voice signal to generate a third voice signal. The third voice signal has a lower intelligibility than the first voice signal (S905).

Next, the processor outputs the first voice signal through the first speaker mounted on the first seat (S906).

At the same time, the processor outputs the third voice signal through the second speaker mounted on the second seat (S907).

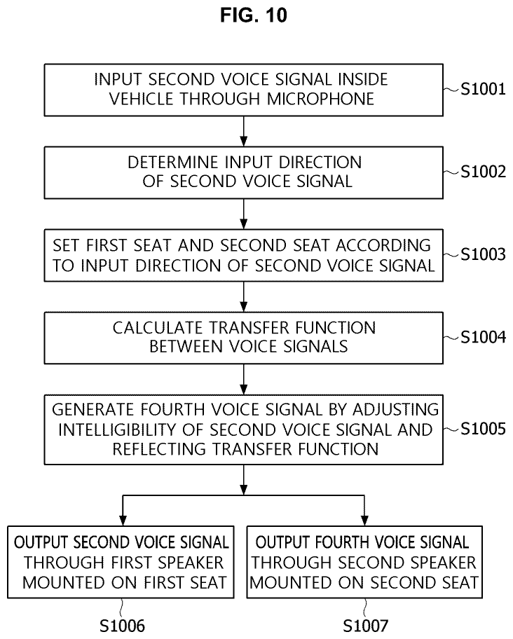

FIG. 10 is a flowchart of a method of controlling a vehicle according to yet another embodiment. Referring to FIG. 10, a second voice signal generated inside the vehicle is input through the microphone mounted inside the vehicle (S1001).

Next, the processor determines an input direction of the second voice signal (S1002).

Next, the processor sets a seat positioned in the input direction of the second voice signal as the first seat, and sets other seats except the first seat as the second seat (S1003).

Next, the processor calculates a transfer function between a voice signal transmitted from the microphone to the auxiliary microphone disposed in the second seat and a voice signal transmitted from the second speaker to the auxiliary microphone (S1004).

Next, the processor adjusts the intelligibility of the second voice signal and reflects the calculated transfer function together to generate a fourth voice signal. The fourth voice signal has a lower intelligibility than the second voice signal (S1005).

Next, the processor outputs the second voice signal through the first speaker mounted on the first seat (S1006).

At the same time, the processor outputs the fourth voice signal through the second speaker mounted on the second seat. In this case, the processor adjusts a time point at which the fourth voice signal is output based on the distance between the first seat and the second seat (S1007).

The term “~unit” used in the present embodiment refers to software component or hardware components such as a field-programmable gate array (FPGA) or an application specific integrated circuit (ASIC), and “~unit” performs certain functions. However, the “~unit” is not limited to software or hardware. The “~unit” may be configured to reside in an addressable storage medium, or may be configured to reproduce one or more processors. Therefore, for example, “~unit” includes components such as software components, object-oriented software components, class components, and task components, and includes processes, functions, attributes, procedures, sub-routines, segments of program code, drivers, firmware, micro codes, circuits, data, a database, data structures, tables, arrays, and variables. Functions provided in the components and the “~unit” may be combined into smaller numbers of components and “~units,” or may be further divided into additional components and “~units.” Furthermore, the components and “~units” may be implemented to reproduce one or more CPUs in a device or a security multimedia card.

A sound control device and method according to an embodiment can ensure security and privacy of the contents of a hands-free call.

Although the preferred embodiments of the present disclosure have been described above, it is understood that those skilled in the art can make various changes and modifications to the present disclosure without departing from the spirit and scope of the present disclosure set forth in the claims below.

What is claimed is:

1. A sound control device for a vehicle, the sound control device comprising:
a plurality of speakers mounted in the vehicle, at least one of the plurality of speakers being configured to output a first voice signal;
a microphone mounted inside the vehicle and configured to receive a second voice signal generated inside the vehicle;
a first processing unit configured to adjust an intelligibility of the first voice signal to generate a third voice signal and adjust an intelligibility of the second voice signal to generate a fourth voice signal; and
a second processing unit configured to control the first voice signal and the second voice signal to be output through a first speaker of the plurality of speakers mounted on a first seat and the third voice signal and the fourth voice signal to be output through a second speaker of the plurality of speakers mounted on a second seat.

2. The sound control device of claim 1, wherein the third voice signal has a lower intelligibility than the first voice signal, and the fourth voice signal has a lower intelligibility than the second voice signal.

3. The sound control device of claim 1, wherein the first processing unit adjusts the intelligibility through at least one of pitch shifting, time stretching/compression, reverb, distortion, filtering, or phasing.

4. The sound control device of claim 3, wherein the first processing unit adjusts the intelligibility so that each of an articulation index (AI), a speech intelligibility index (SII), and a speech transmission index (STI) of each of the first voice signal and the second voice signal is a preset threshold value or lower.

5. The sound control device of claim 1, further comprising an auxiliary microphone disposed in the second seat.

6. The sound control device of claim 5, wherein the first processing unit calculates a transfer function between a voice signal transmitted from the microphone to the auxiliary microphone and a voice signal transmitted from the second speaker to the auxiliary microphone.

7. The sound control device of claim 6, wherein the first processing unit generates the fourth voice signal by reflecting the transfer function.

8. The sound control device of claim 1, wherein the second processing unit adjusts a time point at which the fourth voice signal is output based on a distance between the first seat and the second seat.

9. The sound control device of claim 1, wherein the first and second seats include the first and second speakers, respectively, each of which is mounted in a headrest.

10. The sound control device of claim 1, wherein the first seat is one of rear row seats, and the second seat is a driver's seat.

11. A method of controlling a sound in a vehicle, the method comprising:
receiving, by a communication device, a first voice signal;
adjusting, by a processor, an intelligibility of the first voice signal and generating a third voice signal; and
performing, by the processor, control to output the first voice signal through a first speaker mounted on a first seat and output the third voice signal through a second speaker mounted on a second seat.

12. The method of claim 11, wherein the third voice signal has a lower intelligibility than the first voice signal.

13. The method of claim 11, wherein the generating of the third voice signal includes adjusting the intelligibility through at least one of pitch shifting, time stretching/compression, reverb, distortion, filtering, and phasing.

14. The method of claim 11, wherein the generating of the third voice signal includes adjusting the intelligibility so that each of an articulation index (AI), a speech intelligibility index (SII), and a speech transmission index (STI) of the first voice signal is a preset threshold value or lower and generating the third voice signal.

15. A method of controlling a sound in a vehicle, the method comprising:
receiving, by a microphone, a second voice signal generated inside the vehicle through the microphone mounted inside the vehicle;
adjusting, by a processor, an intelligibility of the second voice signal and generating a fourth voice signal; and
performing, by the processor, control to output the second voice signal through a first speaker mounted on a first seat and output the fourth voice signal through a second speaker mounted on a second seat.

16. The method of claim 15, wherein the fourth voice signal has a lower intelligibility than the second voice signal.

17. The method of claim 15, wherein the generating of the fourth voice signal includes adjusting the intelligibility through at least one of pitch shifting, time stretching/compression, reverb, distortion, filtering, and phasing.

18. The method of claim 17, wherein the generating of the fourth voice signal includes adjusting the intelligibility so that each of an articulation index, a speech intelligibility index, and a speech transmission index of the second voice signal is a preset threshold value or lower and generating the fourth voice signal.

19. The method of claim 15, wherein the generating of the fourth voice signal includes:
calculating a transfer function between a voice signal transmitted from the microphone to an auxiliary microphone disposed in the second seat and a voice signal transmitted from the second speaker to the auxiliary microphone; and
reflecting the transfer function and generating the fourth voice signal.

20. The method of claim 15, wherein the performing of the control to output the fourth voice signal includes adjusting a time point at which the fourth voice signal is output based on a distance between the first seat and the second seat.
